(19) United States
(12) Patent Application Publication
(10) Pub. No.: US 2013/0323470 A1
(43) Pub. Date: Dec. 5, 2013

(54) CONDUCTIVE STRUCTURE FOR PANEL AND MANUFACTURING METHOD THEREOF

(71) Applicant: INNOLUX CORPORATION, Miao-Li County (TW)

(72) Inventors: HUEI-YING CHEN, KAOHSIUNG CITY (TW); CHIA-CHI HO, TAINAN CITY (TW)

(73) Assignee: INNOLUX CORPORATION, Miao-Li County (TW)

(21) Appl. No.: 13/891,968

(22) Filed: May 10, 2013

(30) Foreign Application Priority Data
May 30, 2012 (TW) 101119385

(51) Int. Cl. H01B 5/14; H01B 1/02

(52) U.S. Cl. CPC H01B 5/14; H01B 1/02
USPC 428/157; 216/17

(57) ABSTRACT

A conductive structure for a panel is formed on a plate and includes a first metal layer, a nitride layer, and a second metal layer. The first metal layer is located on the plate and has a first side surface and a lower surface connected to the first side surface, while the lower surface makes contact with the plate. The first metal layer contains molybdenum. The nitride layer is located on the first metal layer and has a second side surface. The nitride layer contains molybdenum. The second metal layer is located on the nitride layer and has a third side surface. The second side surface is adjacent to the first side surface and the third side surface, to form an inclined surface. An included angle between the inclined surface and the lower surface is between 20 degrees and 75 degrees.

### BACKGROUND OF THE INVENTION

1. Field of the Invention

The present disclosure relates to a conductive structure and a manufacturing method thereof; in particular, to a conductive structure for a panel and the manufacturing method thereof.

2. Description of Related Art

In the present liquid crystal displays (LCDs), the conductive lines, such as scan lines and data lines, in the transistor array substrate are usually made by sputtering, photolithography, and etching. Specifically, after a metal layer is made by sputtering, a photoresist layer is formed on the metal layer, while the photoresist layer exposes the metal layer partially. Then, etch the metal layer by using the photoresist layer as a mask, and thus, the conductive lines are complete.

FIG. 1 is a schematic cross-sectional view of a conductive line in a prior transistor array substrate after etching. Referring to FIG. 1, after the metal layer (not shown) on the substrate 100 is etched to form the conductive line 110, the side surface of the conductive line 110 sometimes becomes an inclined side surface 111, and an included angle A1 between the inclined side surface 111 and a plane 101 of the substrate 100 is greater than 90 degrees.

In detail, the conductive line 110 has a top surface 112 and a lower surface 114, where the top surface 112 is opposite to the lower surface 114 that is in contact with the plane 101 of the substrate 100. In the view of FIG. 1, the area of the top surface 112 is larger than the area of the lower surface 114, and the width W1 of the conductive line 110 is substantially gradually decreased from the top surface 112 to the lower surface 114, so as to form the inclined side surface 111.

However, if the following process needs vacuum deposition, such as sputtering, the inclined side surface 111 will have a negative effect on the vacuum deposition. In detail, the part of the conductive line 110 at the inclined side surface 111 covers the plane 101, so that it is difficult to make a film on the part of the plane 101 under the inclined side surface 111 by deposition. Therefore, after the vacuum deposition, a cavity may create between the inclined side surface 111 and the plane 101, so as to decrease structural strength. Thus, it is possible to cause the conductive line 110 to break.

### SUMMARY OF THE INVENTION

The present disclosure is to a conductive structure using for a panel, and the conductive structure can reduce a chance of creating the cavity after vacuum deposition.

The present disclosure is also to a manufacturing method for the conductive structure.

According to an embodiment of the present disclosure, a conductive structure for a panel is provided and is formed on an upper surface of a plate. The conductive structure includes a first metal layer, a nitride layer, and a second metal layer. The first metal layer is located on the upper surface, and has a first side surface, and a lower surface connected to the first side surface. The first metal layer contains molybdenum, and the lower surface makes contact with the upper surface. The nitride layer is located on the first metal layer and has a second side surface, and the nitride layer contains molybdenum. The second metal layer is located on the nitride layer and has a third side surface, and the second side surface is adjacent to the first side surface and the third side surface, to form an inclined surface. An included angle between the inclined surface and the lower surface is between 20 degrees and 75 degrees.

According to another embodiment of the present disclosure, a manufacturing method for the conductive structure is provided and includes the following steps. First, a first vacuum deposition is performed to form a first metal layer on an upper surface of a plate, where the first metal layer contains molybdenum, and the first metal layer has a lower surface in contact with the upper surface. Next, a nitride layer is formed on the first metal layer, where the nitride layer contains molybdenum. Next, a second metal layer is formed on the nitride layer. Next, the first metal layer, the nitride layer, and the second metal layer are patterned so as to expose the upper surface partially and to make the same side surface of the first metal layer, the nitride layer, and the second metal layer to form an inclined surface. An included angle between the inclined surface and the lower surface is between 20 degrees and 75 degrees.

In order to further the understanding regarding the present disclosure, the following embodiments are provided along with illustrations to facilitate the disclosure of the present disclosure.

### BRIEF DESCRIPTION OF THE DRAWINGS

FIG. 1 is a schematic cross-sectional view of a conductive line in a prior transistor array substrate after etching.

FIG. 2 is a schematic cross-sectional view of a panel using a conductive structure in an embodiment of the present disclosure.

FIG. 3 is a schematic cross-sectional view of a conductive structure for a panel in another embodiment of the present disclosure.

FIGS. 4A to 4E are schematic cross-sectional views of the process of a manufacturing method for the conductive structure shown in FIG. 3.

FIGS. 5A and 5B are schematic cross-sectional views of the process of forming a nitride layer in another embodiment of the present disclosure.

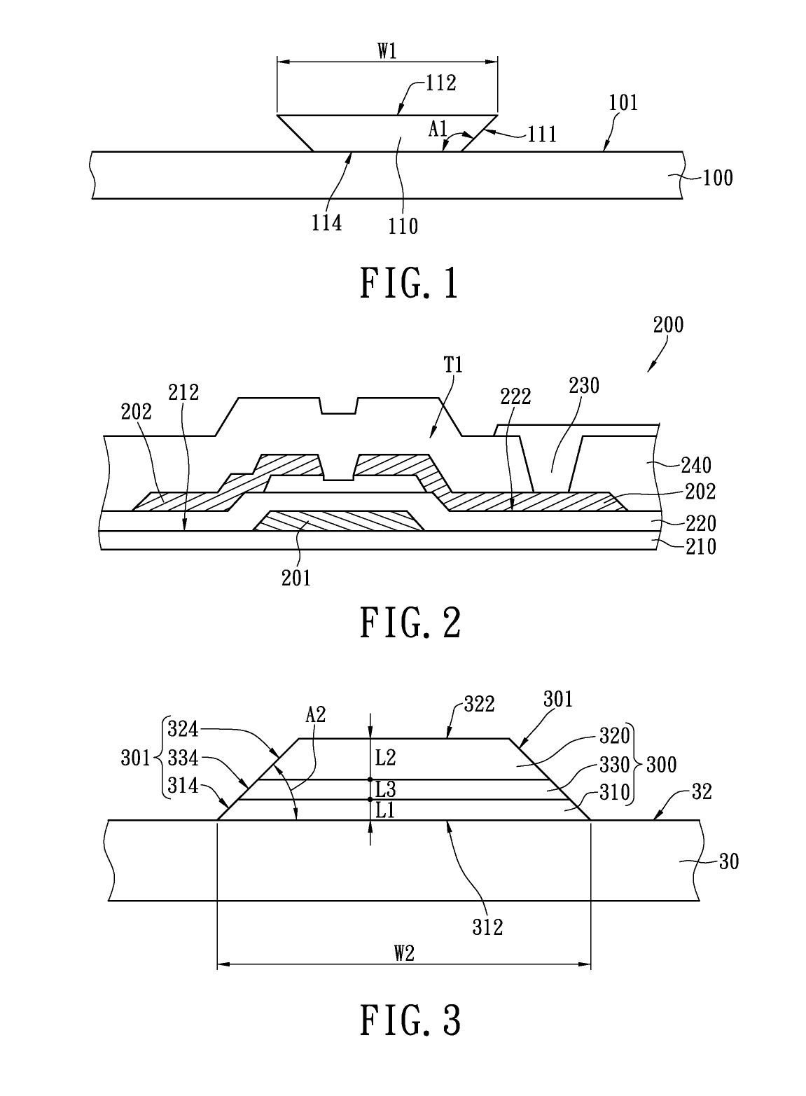

### DETAILED DESCRIPTION OF THE PREFERRED EMBODIMENTS

A plurality of conductive structures according to multiple embodiments of the present disclosure may be used in many kinds of panels. For example, the panels may include touch sensor panels (TSPs) and transistor array substrates within displays, and the display is such as a liquid crystal display (LCD), a plasma display, or an Organic Light-Emitting Diode (OLED) display.

One of the conductive structures according to the embodiments may form a plurality of conductive wires in the TSP or the transistor array substrate. For example, the conductive wire may be a scan line, a data line, a common line, or a peripheral circuit in a transistor array substrate, in which the peripheral circuit of the transistor array substrate may include shorting bars or repair lines. Alternatively, the conductive wire may be a wire that is connected to a sensing electrode in a TSP.

FIG. 2 is a schematic cross-sectional view of a panel using a conductive structure in an embodiment of the present disclosure. Referring to FIG. 2, which shows two kinds of the conductive structures 201, 202 and a panel 200 using the conductive structures 201, 202. The panel 200 as shown in FIG. 2 may be a transistor array substrate within an LCD, so that the panel 200 may have a plurality of transistors T1. (FIG. 2 shows only one [symbol] transistors T1.) However, the panel 200 can be replaced by a TSP in another embodiment. Thus, it is necessary to note that the type of the panel 200 shown in FIG. 2 is merely illustrated as an example and not intended to limit the use of the conductive structure in the present disclosure.

In the embodiment as shown in FIG. 2, the conductive structure 201 is formed on an upper surface 212 of a substrate 210 and covered by an insulating layer 220. The conductive structure 202 is formed on an upper surface 222 of the insulating layer 220 and covered by an insulating layer 240. The substrate 210 is such as a glass substrate. The conductive structure 201 can form a scan line and a gate of the transistor T1, while the conductive structure 202 can form a data line, a source, and a drain of the transistor T1. The part of the conductive structure 202 connecting to a pixel electrode 230 is the source of the transistor T1.

FIG. 3 is a schematic cross-sectional view of a conductive structure for a panel in another embodiment of the present disclosure. Referring to FIG. 3, a conductive structure 300 according to the embodiment may be formed on an upper surface 32 of a plate 30 and may be the conductive structure 201 or 202 shown in FIG. 2. Therefore, when the conductive structure 300 is the conductive structure 201, the plate 30 may be the substrate 210 shown in FIG. 2. When the conductive structure 300 is the conductive structure 202, the plate 30 may include the substrate 210 and the insulating layer 220 located on the substrate 210.

The conductive structure 300 has an inclined surface 301, a lower surface 312, and a top surface 322. The top surface 322 is located opposite to the lower surface 312, and the inclined surface 301 is connected to the top surface 322 and the lower surface 312, and is located between the top surface 322 and the lower surface 312. The lower surface 312 makes contact with the upper surface 32, and an included angle A2 between the inclined surface 301 and the lower surface 312 is less than 90 degrees. For example, the included angle A2 is between 20 degrees and 75 degrees. In view of the FIG. 3, the area of the top surface 322 is less than the area of the lower surface 312, and the width W2 of the conductive structure 300 essentially and gradually increases from the top surface 322 to the lower surface 312, so that the part of the conductive structure 300 at the inclined surface 301 do not cover the upper surface 32.

Therefore, when performing the following vacuum deposition, such as sputtering, chemical vapor deposition (CVD), or evaporation, to form deposits (for example, the insulating layers 220 and 240 as shown in FIG. 2) on the upper surface 32 and the conductive structure 300, the deposits can deposit on the inclined surface 301. Hence, the chance of creating the cavity between the inclined surface 301 and the upper surface 32 can be reduced so as to prevent the structural strength of the conductive structure 300 from reducing, thereby reducing the possibility that the conductive wire (such as a scan line, a data line, or a common line) made of the conductive structure 300 is broken.

The conductive structure 300 has a multilayer structure. Specifically, the conductive structure 300 includes a first metal layer 310, a second metal layer 320, and a nitride layer 330, where the first metal layer 310 is located on the upper surface 32 of the plate 30, the nitride layer 330 is located on the first metal layer 310, and the second metal layer 320 is located on the nitride layer 330. Thus, the nitride layer 330 is located between the first metal layer 310 and the second metal layer 320. Moreover, the nitride layer 330 may be used as an adhesive layer for bonding the first metal layer 310 and the second metal layer 320.

The first metal layer 310 has a first side surface 314 and a lower surface 312 which is connected to the first side surface 314. The nitride layer 330 has a second side surface 334, and the second metal layer 320 has a third side surface 324. The second side surface 334 is located between the first side surface 314 and the third side surface 324, and is adjacent to the first side surface 314 and the third side surface 324 so as to form the inclined surface 301, where the inclined surface 301 includes the first side surface 314, the second side surface 334, and the third side surface 324.

The first metal layer 310 may be made of one kind of metal material or multiple kinds of metal materials, so that the first metal layer 310 may be an alloy layer or a metal layer which is essentially consisted of single kind of metal material. The first metal layer 310 contains molybdenum, and the preferred atomic percent of molybdenum is above 80%. The first metal layer 310 may be a molybdenum alloy layer or a molybdenum layer, and the molybdenum alloy layer is such as a molybdenum-niobium alloy layer, a molybdenum-tungsten alloy layer, or a molybdenum-titanium alloy layer.

When the first metal layer 310 is the molybdenum layer, the atomic percent of molybdenum contained by the first metal layer 310 may be above 90%, such as 99%. Under the premise of ignoring a trace of impurities contained in the first metal layer 310, the atomic percent of molybdenum in the first metal layer 310 essentially can be 100%. However, when the first metal layer 310 is a molybdenum alloy layer, the atomic percent of molybdenum in the first metal layer 310 may be between 80% and 99%.

The nitride layer 330 not only contains nitrogen, but also contains molybdenum, where the atomic percent of molybdenum in the nitride layer 330 is above 55%. The nitride layer 330 may be a molybdenum nitride layer or a molybdenum nitride alloy layer, and the molybdenum nitride alloy layer is, for example, consisted of a molybdenum-niobium alloy nitride, a molybdenum-tungsten alloy nitride, or a molybdenum-titanium alloy nitride. In other words, the metal material contained by the nitride layer 330 essentially may be merely molybdenum or may include molybdenum and other metal (for example, niobium, tungsten, or titanium). When the nitride layer 330 is the molybdenum nitride layer, the atomic percent of molybdenum in the nitride layer 330 may be essentially between 55% and 98.8%. When the nitride layer 330 is the molybdenum nitride alloy layer, the atomic percent of molybdenum in the nitride layer 330 may be essentially between 65% and 98.5%.

The second metal layer 320 may be consisted of a metal material with high electric conductivity, and the metal material is such as gold, silver, copper, aluminum, or an aluminum-copper alloy. Thus, the second metal layer 320 may be a copper layer or an aluminum-copper alloy layer. In addition, the thickness L1 of the first metal layer 310 may be below 10 nm. For example, the thickness L1 of the first metal layer 310 may be below 5 nm or between 5 nm and 10 nm. The thickness L2 of the second metal layer 320 may be between 50 nm and 4000 nm. For example, the thickness L2 of the second metal layer 320 may be 250 nm. The thickness L3 of the nitride layer 330 may be below 100 nm. For example, the thickness L3 of the nitride layer 330 may be 20 nm.

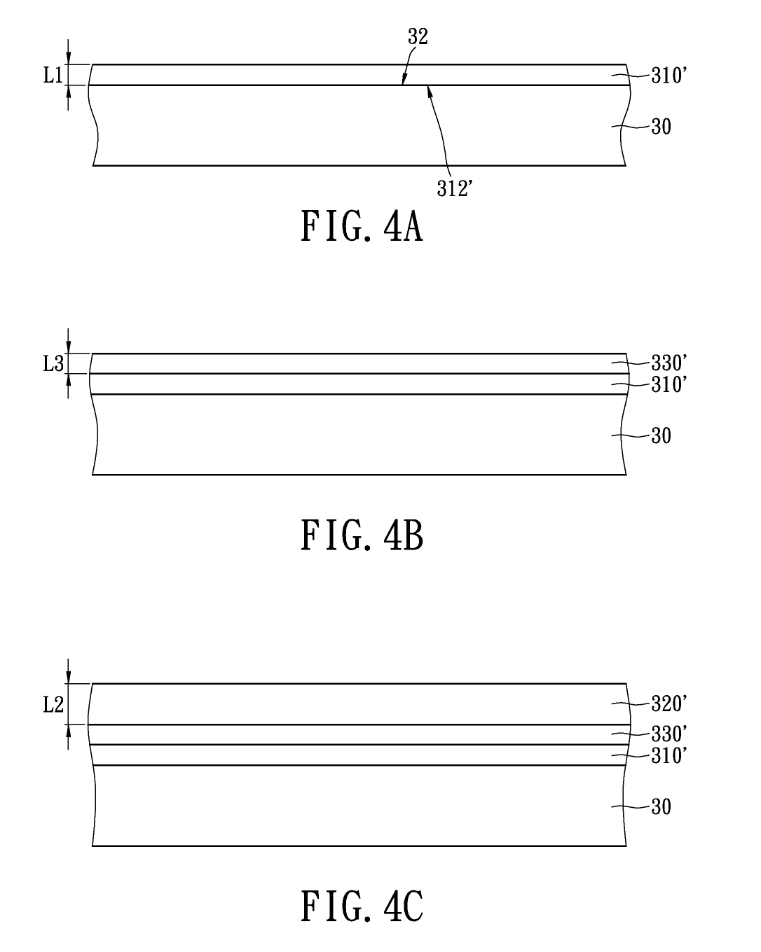

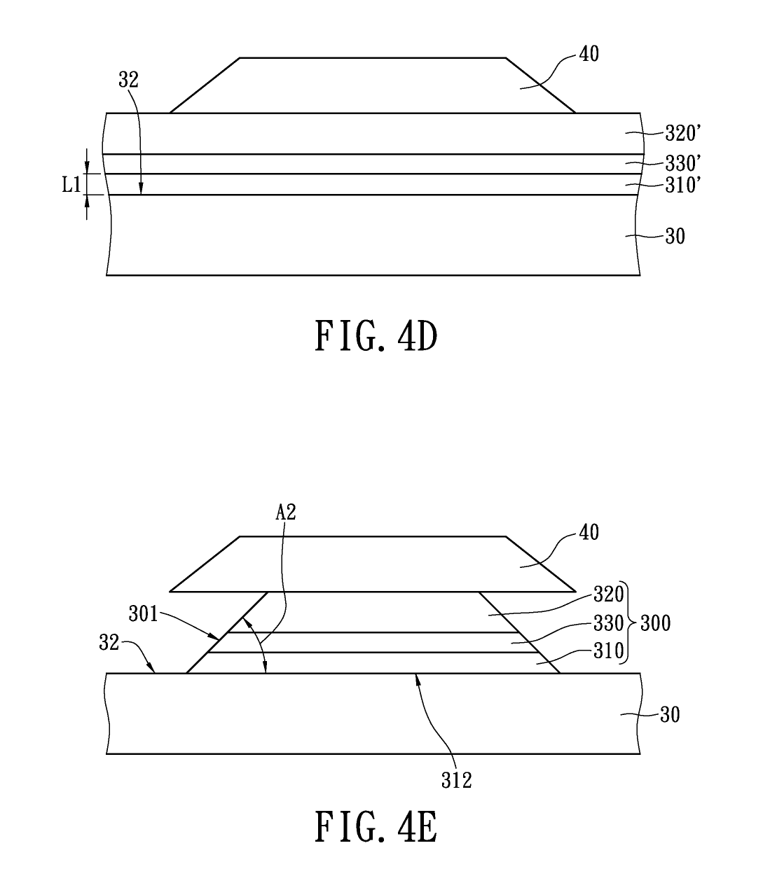

The previous statement mainly describes the conductive structure 300 in structure and material. Next, the following statement will describe the manufacturing method for the conductive structure 300 in detail with FIGS. 4A to 4E.

FIGS. 4A to 4E are schematic cross-sectional views of the process of a manufacturing method for the conductive structure shown in FIG. 3. Referring to FIG. 4A, in the manufacturing method for the conductive structure 300 according to the embodiment, first, perform a first vacuum deposition to form a first metal layer 310′ on the upper surface 32 of the plate 30. The first vacuum deposition may be sputtering, evaporation, or CVD. The first metal layer 310′ has a lower surface 312′ in contact with the upper surface 32.

The composition of the first metal layer 310′ is the same as the composition of the first metal layer 310 shown in FIG. 3. The thickness of the first metal layer 310′ is the same as the thickness of the first metal layer 310. Therefore, the first metal layer 310′ also has the thickness L1, and the first metal layer 310′ contains above 80% atomic percent of molybdenum. For example, the first metal layer 310′ may be a molybdenum layer or a molybdenum alloy layer, and the molybdenum alloy layer is such as a molybdenum-niobium alloy layer, a molybdenum-tungsten alloy layer, or a molybdenum-titanium alloy layer.

In addition, when the first vacuum deposition is the sputtering, a sputtering target used in the first vacuum deposition may be a molybdenum target or a molybdenum alloy target. The background pressure of the first vacuum deposition may be between 10⁻³ Pa and 10⁻⁶ Pa, in which the background pressure means the pressure inside a process chamber under the condition of preparing sputtering before injecting any gas.

Referring to FIG. 4B, next, a nitride layer 330′ is formed on the first metal layer 310′, and the composition of the nitride layer 330′ is the same as the composition of the nitride layer 330 shown in FIG. 3. The thickness of the nitride layer 330′ is the same as the thickness of the nitride layer 330. Therefore, the nitride layer 330′ also has the thickness L3, and the nitride layer 330′ contains above 55% atomic percent of molybdenum. The nitride layer 330′ may be a molybdenum nitride layer or a molybdenum nitride alloy layer, and the molybdenum nitride alloy layer is, for example, consisted of a molybdenum-niobium alloy nitride, a molybdenum-tungsten nitride, or a molybdenum-titanium alloy nitride.

The method of forming the nitride layer 330′ may be performing a second vacuum deposition, in which the second vacuum deposition may be sputtering, evaporation, or CVD. When the second vacuum deposition is the sputtering, the nitride layer 330′ may be formed by at least two kinds of sputterings according to the kind of the target used by the second vacuum deposition. The difference between the two kinds of sputterings is mainly whether nitrogen gas is injected into the process chamber during the second vacuum deposition.

In detail, when the second vacuum deposition uses the molybdenum target or the molybdenum alloy target as the sputtering target, the nitrogen gas is injected into the process chamber where the plate 30 is disposed during the second vacuum deposition to form the nitride layer 330′. The first vacuum deposition and the second vacuum deposition both can use the same sputtering target, so that the first vacuum deposition and the second vacuum deposition are both performed in the same process chamber. Thus, the plate 30 can be retained in an environment where the pressure is less than the atmospheric pressure during the first vacuum deposition and the second vacuum deposition, so as to keep the qualities of the first metal layer 310′ and the nitride layer 330′.

When the second vacuum deposition uses the molybdenum nitride target or the molybdenum nitride alloy target, for example, consisted of the molybdenum-niobium alloy nitride, the molybdenum-tungsten alloy nitride, or the molybdenum-titanium alloy nitride as the sputtering target, only the basic gas for sputtering (such as argon gas) may be injected into the process chamber where the plate 30 is disposed without injecting the nitrogen gas additionally during the second vacuum deposition.

Although the sputtering target used by the second vacuum deposition may be the molybdenum nitride target or the molybdenum nitride alloy target which is different from the sputtering target of the first vacuum deposition, it can make the plate 30 retained in the environment where the pressure is less than the atmospheric pressure during the first vacuum deposition and the second vacuum deposition by using a vacuum chamber or a mechanism for switching targets. Therefore, it can keep the qualities of the first metal layer 310′ and the nitride layer 330′.

Referring to FIG. 4C, then, a second metal layer 320′ is formed on the nitride layer 330′, and the method of forming the second metal layer 320′ may be performing the vacuum deposition, such as the sputtering, the evaporation, or the CVD, in which the background pressure of the vacuum deposition may be between 10⁻³ Pa and 10⁻⁶ Pa. During from forming the nitride layer 330′ to forming the second metal layer 320′, it can make the plate 30 retained in the environment where the pressure is less than the atmospheric pressure by using the vacuum chamber or the mechanism for switching targets. Therefore, it can keep the qualities of the second metal layer 320′.

Based on the above-mentioned description, in the embodiment, the composition of the second metal layer 320′ is the same as the composition of the second metal layer 320 shown in FIG. 3. The thickness of the second metal layer 320′ is the same as the thickness of the second metal layer 320. Therefore, the second metal layer 320′ may be the copper layer or the aluminum-copper alloy layer and has the thickness L2, which may be between 50 nm and 4000 nm, such as 250 nm.

Referring to FIGS. 4D and 4E, next, pattern the first metal layer 310′, the nitride layer 330′, and the second metal layer 320′ so as to form the first metal layer 310, the nitride layer 330, and the second metal layer 320, while the upper surface 32 of the plate 30 is exposed. The conductive structure 300 with the inclined surface 301 is basically complete so far, in which the included angle A2 between the inclined surface 301 and the lower surface 312 is between 20 degrees and 75 degrees.

The method of patterning the first metal layer 310′, the nitride layer 330′, and the second metal layer 320′ include a plurality of implementation means. In the embodiment, the method of patterning the first metal layer 310′, the nitride layer 330′, and the second metal layer 320′ can use photolithography and etching. Specifically, first, a photoresist pattern 40 is formed on the second metal layer 320′ by using the photolithography, and the photoresist pattern 40 exposes partially the second metal layer 320′, as shown in FIG. 4D.

Next, etch the first metal layer 310′, the nitride layer 330′, and the second metal layer 320′ by using the photoresist pattern 40 as a mask. The first metal layer 310′, the nitride layer 330′, and the second metal layer 320′ may be etched by the etchant or the plasma. In other words, the method of etching first metal layer 310′, the nitride layer 330′, and the second metal layer 320′ may be wet etching or dry etching. After patterning the first metal layer 310′, the nitride layer 330′, and the second metal layer 320′, the photoresist pattern 40 can be removed by stripper to form the conductive structure 300 as shown in FIG. 3.

The etchant may be an acidic solution, which has a ph larger than 7. The etchant may contains water, hydrogen peroxide (H₂O₂), and a salt material. In the embodiment, the salt material mainly includes two kinds of salts. One kind of salt contains fluorine, and the other kind of salt does not contain fluorine. For example, the salt material may be a fluorine-free inorganic salt or a fluorinate ammonium salt.

Moreover, in the actual process for manufacturing the conductive structure 300, when the thickness L1 of the first metal layer 310′ is below 14 nm, the etchant basically can remove the part of the first metal layer 310′ which is exposed by the photoresist pattern 40 completely, so that only the part of the first metal layer 310′ (that is first metal layer 310) covered by the photoresist pattern 40 remains. Thus, it prevents the part of the first metal layer 310′ without covered by the photoresist pattern 40 from remaining on the upper surface 32, so as to reduce the chance that the conductive wire made of the conductive structure 300 is short.

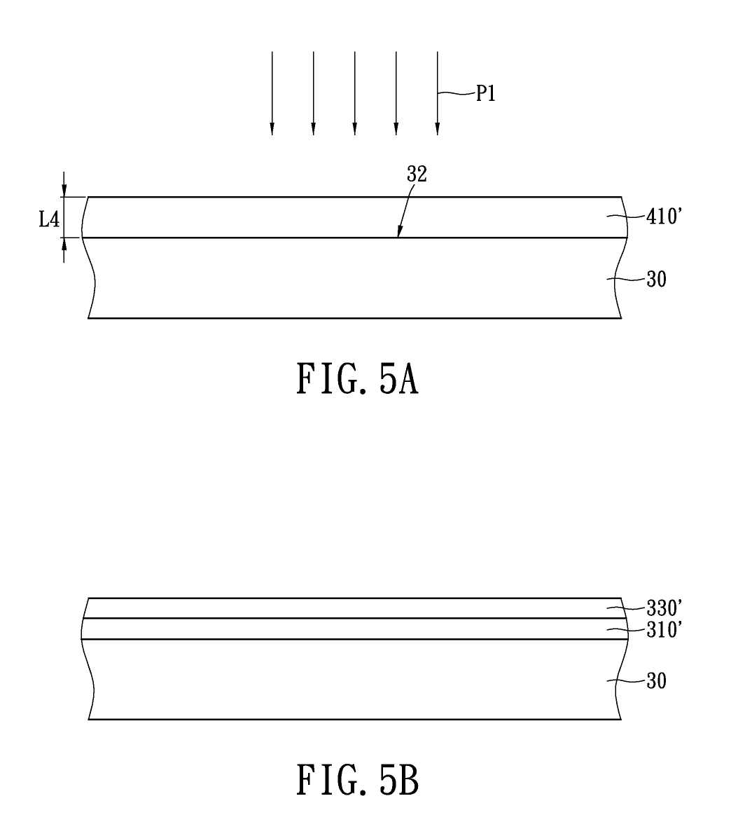

It is necessary to note that the nitride layer 330′ is formed by the vacuum deposition (that is the second vacuum deposition) in the preceding manufacturing method for the conductive structure 300 shown in FIGS. 4A to 4E, but in another embodiment, forming the nitride layer 330′ may use the other method except the vacuum deposition, as shown in FIGS. 5A to 5B.

FIGS. 5A and 5B are schematic cross-sectional views of the process of forming a nitride layer in another embodiment of the present disclosure. The nitride layer according to the embodiment is formed by using the plasma bombardment. In detail, referring to FIG. 5A, first, a first metal layer 410′ is formed on the upper surface 32 of the plate 30, in which the method of forming the first metal layer 410′ is the same as the method of forming the first metal layer 310′ (referring to FIG. 4A). The composition of the first metal layer 410′ is the same as the composition of the first metal layer 310′. However, the thickness L4 of the first metal layer 410′ is larger than the thickness L1 of the first metal layer 310′.

Referring to FIGS. 5A and 5B, next, perform the plasma bombardment to the first metal layer 410′, and a gas source of the plasma bombardment includes a nitrogen gas. Specifically, the nitrogen gas is ionized to generate plasma P1 after injecting the nitrogen gas. Then, an electric field can control the plasma P1 to bombard the first metal layer 410′, so that the part of the first metal layer 410′ turns into the nitride layer 330′. The other part of the first metal layer 410′ that is not transformed becomes the first metal layer 310′.

Based on the above, after the first metal layer 310′ and the nitride layer 330′ are complete, perform the preceding processes shown in FIGS. 4C to 4E in sequence. Then, the photoresist pattern 40 is removed, thereby forming the conductive structure 300 shown in FIG. 3. Since the processes shown in FIGS. 4C to 4E is described in detail in the preceding statement, the processes herein are not described again.

In conclusion, a conductive structure with an inclined surface (for example, the inclined surface 301 shown in FIG. 3) can be formed on a plate by using the first metal layer and the nitride layer. An included angle between the inclined surface and the lower surface (for example, the lower surface 312 shown in FIG. 3) is between 20 degrees and 75 degrees, so that the part of the conductive structure at the inclined surface does not cover the plate.

Therefore, in the process of performing the vacuum deposition (such as sputtering, CVD, or evaporation), the deposits can cover the top surface (such as the top surface 322 shown in FIG. 3) and the inclined surface of the conductive structure completely, so as to reduce the chance of creating the cavity between the inclined surface and the plate. Hence, it can prevent the structural strength of the conductive structure from reducing and reduce the possibility that the conductive wire is broken.

The descriptions illustrated supra set forth simply the preferred embodiments of the present invention; however, the characteristics of the present invention are by no means restricted thereto. All changes, alternations, or modifications conveniently considered by those skilled in the art are deemed to be encompassed within the scope of the present invention delineated by the following claims.

What is claimed is:

1. A conductive structure using for a panel and formed on an upper surface of a plate, comprising:
a first metal layer, located on the upper surface, and having a first side surface and a lower surface connected to the first side surface, wherein the first metal layer contains molybdenum, and the lower surface makes contact with the upper surface;
a nitride layer, located on the first metal layer, and having a second side surface, wherein the nitride layer contains molybdenum; and
a second metal layer, located on the nitride layer, and having a third side surface, wherein the second side surface is adjacent to the first side surface and the third side surface, so as to form an inclined surface, and an included angle between the inclined surface and the lower surface is between 20 degrees and 75 degrees.

2. The conductive structure according to claim 1, wherein the thickness of the first metal layer is below 14 nm.

3. The conductive structure according to claim 2, wherein the thickness of the first metal layer is below 8 nm.

4. The conductive structure according to claim 1, wherein the thickness of the nitride layer is below 40 nm.

5. The conductive structure according to claim 1, wherein the nitride layer contains 55% to 98.8% atomic percent of molybdenum.

6. The conductive structure according to claim 1, wherein the nitride layer contains 65% to 98.5% atomic percent of molybdenum.

7. The conductive structure according to claim 1, wherein the second metal layer is a copper layer.

8. The conductive structure according to claim 1, wherein the plate is a glass substrate.

9. The conductive structure according to claim 1, wherein the plate comprises:
a substrate; and
an insulating layer, located on the substrate and has the upper surface.

10. A manufacturing method for a conductive structure for a panel, comprising:
performing a first vacuum deposition to form a first metal layer on an upper surface of a plate, wherein the first metal layer contains molybdenum, and the first metal layer has a lower surface in contact with the upper surface;
forming a nitride layer on the first metal layer, wherein the nitride layer contains molybdenum;
forming a second metal layer on the nitride layer; and
patterning the first metal layer, the nitride layer, and the second metal layer so as to expose the upper surface partially and to make the same side surfaces of the first metal layer, the nitride layer, and the second metal layer to form an inclined surface, wherein an included angle between the inclined surface and the lower surface is between 20 degrees and 75 degrees.

11. The manufacturing method according to claim 10, wherein the method of forming the nitride layer is performing a second vacuum deposition.

12. The manufacturing method according to claim 11, wherein a sputtering target used in the second vacuum deposition is a molybdenum nitride target or a molybdenum nitride alloy target.

13. The manufacturing method according to claim 11, wherein a sputtering target used in the second vacuum deposition is a molybdenum target or a molybdenum alloy target.

14. The manufacturing method according to claim 13, wherein a nitrogen gas is injected into a process chamber where the plate is disposed during the second vacuum deposition.

15. The manufacturing method according to claim 10, wherein the method of forming the nitride layer comprises performing a plasma bombardment to the first metal layer, and a gas source of the plasma bombardment comprises a nitrogen gas.

16. The manufacturing method according to claim 10, wherein the method of patterning the first metal layer, the nitride layer, and the second metal layer comprises:
etching the first metal layer, the nitride layer, and the second metal layer by using a photoresist pattern as a mask.

17. The manufacturing method according to claim 16, wherein the first metal layer, the nitride layer, and the second metal layer are etched by an etchant or a plasma, and the etchant contains water, hydrogen peroxide, and a salt material which is a fluorine-free inorganic salt or a fluorinate ammonium salt.

18. The manufacturing method according to claim 10, wherein the plate is a glass substrate.

19. The manufacturing method according to claim 10, wherein the plate comprises:
a substrate; and
an insulating layer, located on the substrate and has the upper surface.

20. The manufacturing method according to claim 10, wherein the second metal layer is a copper layer.
